(19) United States
(12) Patent Application Publication
(10) Pub. No.: US 2014/0210946 A1
(43) Pub. Date: Jul. 31, 2014

(54) NON-DESTRUCTIVE INSPECTION APPARATUS AND METHOD FOR TOUGHENED COMPOSITE MATERIALS

(71) Applicant: NATIONAL TAIWAN UNIVERSITY, TAIPEI CITY (TW)

(72) Inventor: HAO MING HSIAO, TAIPEI CITY (TW)

(73) Assignee: NATIONAL TAIWAN UNIVERSITY, TAIPEI CITY (TW)

(21) Appl. No.: 13/898,549

(22) Filed: May 21, 2013

(30) Foreign Application Priority Data
Jan. 28, 2013 (TW) 102103143

(51) Int. Cl. G06T 7/00; H04N 13/02

(52) U.S. Cl. CPC G06T 7/0004; H04N 13/0203
USPC 348/46

(57) ABSTRACT

A non-destructive composite material inspection apparatus and method thereof inspect the fiber direction and fracture toughness. The apparatus includes a light module and a stereoscopic microcamera module. The light module generates a polarized light that has a polarization orientation projecting to an inspection area on the surface layer of the composite material. The stereoscopic microcamera module captures the reflection light from the inspection area and outputs an image. When the polarization orientation and the fiber direction are parallel, the image is a bright field image. When the polarization orientation and the fiber direction are orthogonal, the image is a dark field image. The bright and dark field images show the fiber direction and toughened particle distribution and the toughness of the composite material is then predicted.

### BACKGROUND

1. Field of the Invention

The instant disclosure relates to an inspection apparatus and method; in particular, to a non-destructive inspection apparatus and method for the fracture toughness and fiber direction of composite materials.

2. Description of Related Art

Composite materials, which include matrix and reinforcement materials, have been known in the art. Reinforcement materials such as carbon fiber or glass fiber enhance the strength and resistance of the final product. The matrix shapes the product and protects the reinforcement materials from wearing out by mechanical contacts.

The composite materials with the reinforcement materials commonly exhibit light weight, high strength and high resistance to extreme weather conditions, corrosion and fatigue. Hence, composite materials with the reinforcement materials are widely implemented in various fields.

Because of the rising price of oil, composite materials have been implemented in aircraft manufacturing to reduce the oil consumption. By way of example, composite materials are used in aircraft to reduce the overall weight and therefore the oil consumption in operation. In this regard, composite materials are widely implemented in the aircraft body, including wings, tail wing and the other main structures, in the aerospace industry. However, the aircraft sustains a complex variation of the mechanical stresses during takeoff and landing. Moreover, the high altitude operation environment of the aircraft results in more strict requirements of composite materials.

Composite materials used in the aerospace industry are formed by stacking multiple layers which contain fibers. The fiber direction of each layer may not be identical. The fibers in one layer are arranged at the substantially same direction and can strengthen the composite strength in that specific direction. In addition, toughened particles are added in the composite materials, distributing between interlaminar layers. The toughened particles enhance the toughness of composite materials and prevent fatigue crack propagation in the composite materials. The size and distribution of the toughened particles are closely related to the fracture toughness (G_{IC}) and compression-after-impact strength (CAI). Therefore, the size and distribution of the toughened particles have to be precisely regulated during the manufacturing of composite materials.

The conventional inspection of the toughened composite materials is a destructive optical evaluation. For example, firstly the testing composite material is sliced into multiple pieces. The inspection is conducted under optical microscope or scanning electron microscope (SEM). However, the cross-section represents only a small portion of the composite material and the distribution of toughened particles cannot be properly evaluated. In other words, the conventional optical inspection fails to provide accurate information regarding the distribution of toughened particles such that the G_{IC} and CAI cannot be properly predicted. Another type of inspection is performed by destructive mechanical tests. The abovementioned methods require considerable time and high cost. Additionally, the information is not immediately provided to the production line and may result in defected products.

### SUMMARY OF THE INVENTION

The instant disclosure provides a non-destructive composite material inspection apparatus. The surface layer of composite material has a direction of fibers and a distribution of toughened particles. The fibers are aligned to a fiber direction and the toughened particles are distributed on the surface. The inspection apparatus includes a first light module and a stereoscopic microcamera module. The first light module projects a first light ray on a portion of the composite material for inspection. The first light ray is a polarized light having a polarization orientation. The polarization orientation and the fiber direction can be orthogonal or parallel. The stereoscopic microcamera module captures the reflection light from the inspection area and outputs an image. When the polarization orientation and the fiber direction are parallel, the captured image is a bright field image. The bright field image shows the fiber direction and toughened particle distribution on the surface layer of the composite material within the inspection area. When the polarization orientation and the fiber direction are orthogonal, the captured image is a dark field image. The dark field image provides information of toughened particle distribution for predicting the fracture toughness of the composite material.

Another embodiment of the instant disclosure provides a non-destructive composite material inspection apparatus. The inspection apparatus includes a light module, an adjustment assembly and a stereoscopic microcamera module. The light module creates a light ray which is unpolarized. The adjustment assembly is coupled to the light module to adjust the incident light angle and direction in respect to the composite material. The incident light angle is the Brewster's angle. The stereoscopic microcamera module captures a reflection light from the inspection area and outputs an image. When the adjustment assembly adjusts the incident light direction to make the polarization orientation of the reflection light parallel to the fiber direction, the captured image is a bright field image. The bright field image shows the fiber direction and toughened particle distribution on the surface layer of the composite material within the inspection area. When the polarization orientation of the reflection light and the fiber direction are orthogonal, the captured image is a dark field image. The dark field image provides information of toughened particle distribution for predicting the toughness of the composite material.

According to another embodiment of the instant disclosure, a method of non-destructive inspection of composite materials is provided. The method includes a first light module to generate a first light ray. The first light ray, being a polarized light, projects to the inspection area of the composite material in a predetermined angle and direction. Secondly, a stereoscopic microcamera module captures the reflection light from the inspection area and outputs an image. The polarization orientation, incident angle or direction of the first light is adjusted to allow the stereoscopic microcamera module for outputting a bright field image. The bright field image is analyzed and information regarding fiber direction and toughened particle distribution of the composite material is derived. Subsequently, the polarization orientation, the incident angle or the direction of the first light ray is adjusted to allow the stereoscopic microcamera module for outputting a dark field image. The dark field image is analyzed and information (parameters) regarding toughened particle distribution on the surface of the composite material is derived.

In this regard, the inspection apparatus of the instant disclosure is non-destructive to the target composite material by an optical technique. Hence, the inspection apparatus can be used on the production line without interruption. In addition, the fiber direction or toughened particle distribution on the surface layer of the composite materials can be obtained immediately.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

The patent or application file contains at least one drawing executed in color. Copies of this patent or patent application publication with color drawings will be provided by the Office upon request and payment of necessary fee.

FIG. 1 is a perspective view of a non-destructive composite material inspection apparatus in accordance with an embodiment of the instant disclosure.

FIG. 2A is a schematic diagram showing a first light ray of a first light module projecting to the inspection area in accordance with an embodiment of the instant disclosure.

FIG. 2B shows an image output by a stereoscopic microcamera in the condition shown in FIG. 2A.

FIG. 2C is a schematic diagram showing a first light ray of a first light module projecting to the inspection area in accordance with an embodiment of the instant disclosure.

FIG. 2D shows an image output by a stereoscopic microcamera in the condition shown in FIG. 2C.

FIG. 3 is a top schematic view of a first light module and a second light module lighting on different positions on the surface of a composite material.

FIG. 4 is a flow chart of a non-destructive composite material inspection apparatus in accordance with an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

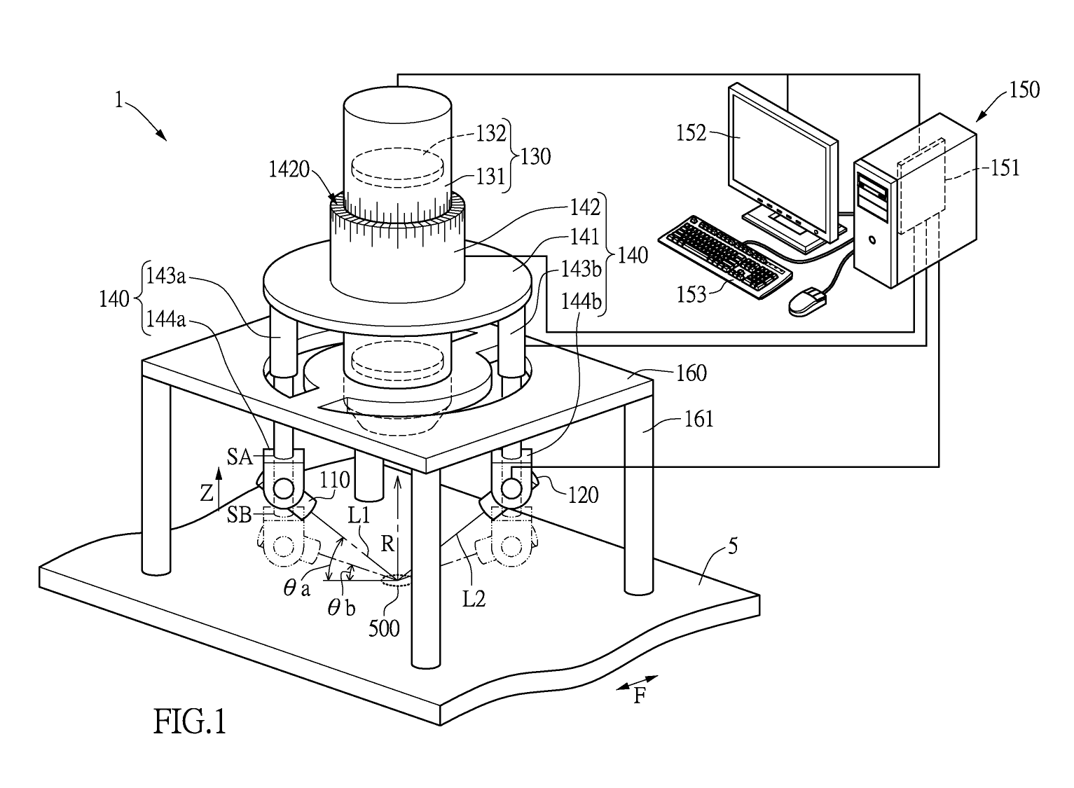

Please refer to FIG. 1 which shows a non-destructive composite material inspection apparatus in accordance with an embodiment of the instant disclosure. The composite material inspection apparatus 1 is suitable to evaluate the composite material 5. The composite material 5 is constituted by fibers and matrix enclosed therein. The composite material 5 can be stacked composite material, continuous fiber composite material, granular composite material or short fiber composite material. In the instant embodiment, the composite material 5 can be stacked or single-layered composite material or prepreg. The fibers of the surface layer of the composite material 5 have a fiber direction F, and a distribution of toughened particles scattering on the surface of the composite material.

The composite inspection apparatus 1 includes a first light module 110, a second light module 120, a stereoscopic microcamera module 130, an adjustment assembly 140 and a processing module 150. The first and second light modules 110, 120 generate a first light ray L1 and a second light ray L2 respectively. The first and second light rays L1, L2, being polarized light, project on an inspection area 500 of the composite material 5. Also, the first and second light rays L1, L2 have the same polarization orientation.

When the first and second light rays L1, L2 project to the inspection area 500, the stereoscopic microcamera module 130 captures a reflection light R from the inspection area 500 and outputs an image. The detailed description is elaborated herein.

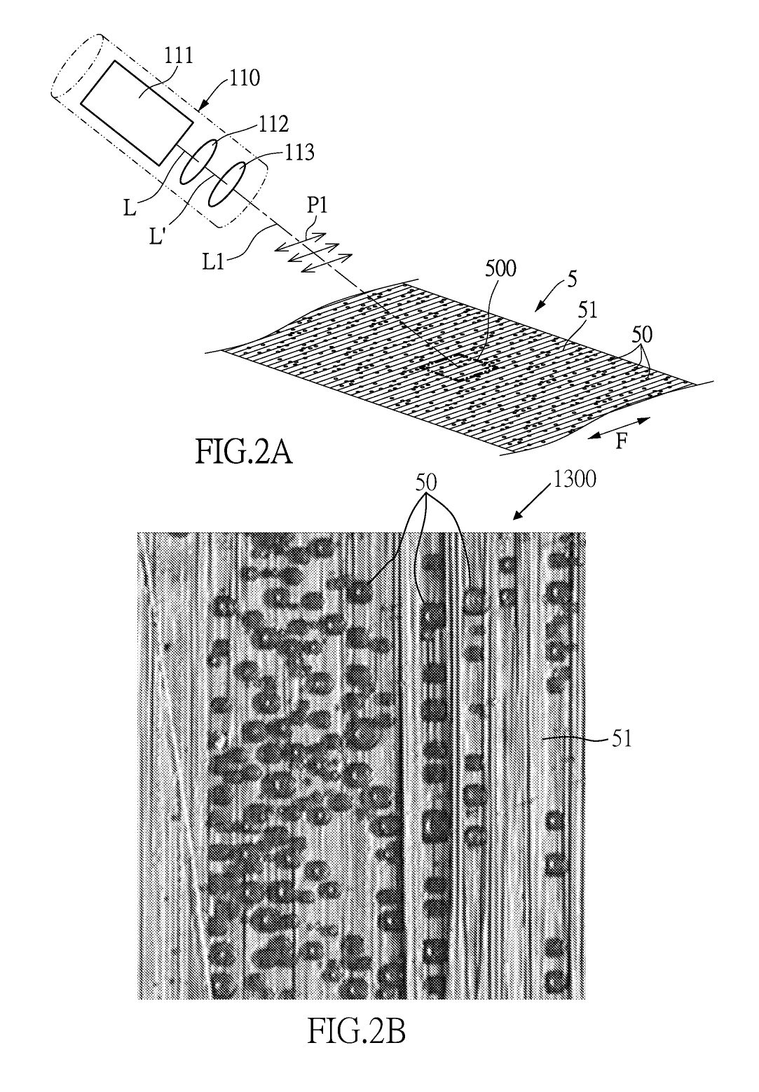

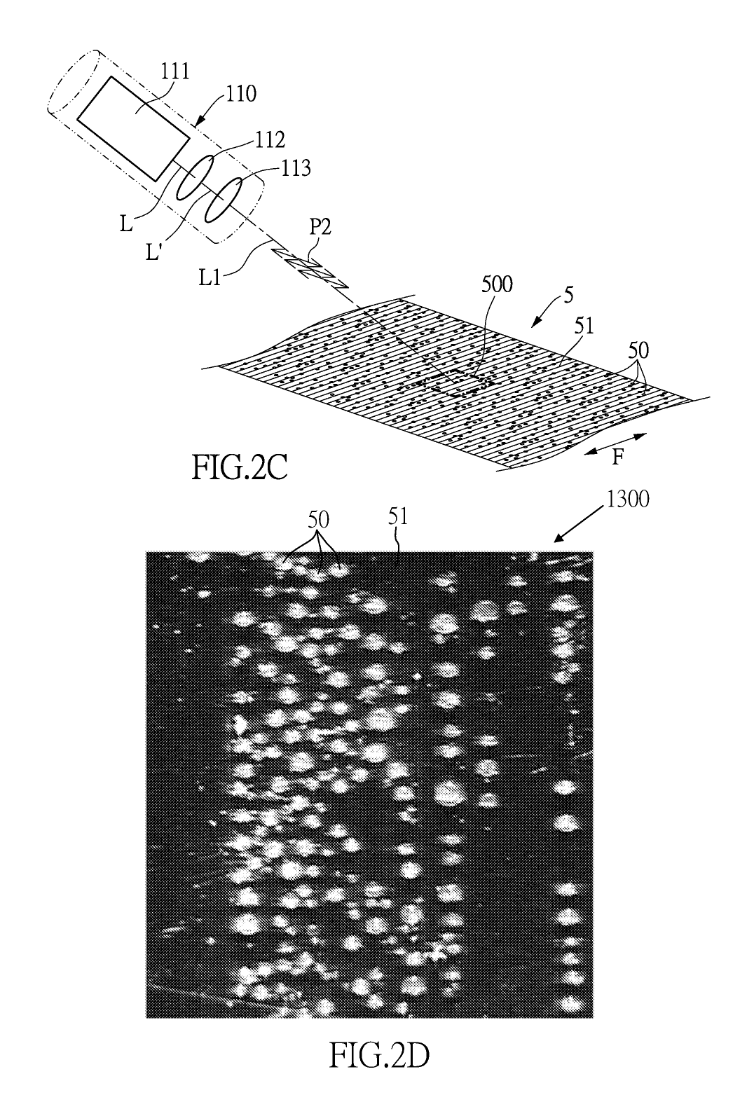

Please refer to FIGS. 2A to 2D. FIGS. 2A and 2C show schematic diagrams of the first light ray of the first light module projecting to the inspection area. FIGS. 2B and 2D show the image output by the stereoscopic microcamera in the condition of FIGS. 2A and 2C respectively.

Referring to FIG. 2A, the first light module 110 includes a first light source 111, polarizer 112 and polarization adjustment element 113. The second light module 120 includes similar components as the first light module 110. The first light source 111 can be laser or optical fiber to generate an initial light L. The initial light L is unpolarized.

The polarizer 112 is disposed on the light emitting face of the first light source 111 and standing on the light path to polarize the initial light L. In other words, the initial light L is firstly emitted by the first light source 111 and polarized by the polarizer 112 to a polarized light L′. In the instant embodiment, the polarizer 112 is a linear polarizer and therefore the polarized light L′ is linearly polarized.

The polarization adjustment element 113 is an optional component to control the polarization orientation of the polarized light L′ emitted by the polarizer 112. The first light ray L1 then exhibits a specific polarization orientation. In another embodiment, the polarization adjustment element 113 can be a magnetic polarization rotator for rotating the polarization orientation by magnetic field, for example, Faraday rotator. Additionally, the polarization adjustment element 113 is disposed on the light emitting face of the polarizer 112 and standing on the light path of the polarized light L′. In another embodiment, the polarization element 113 can be a rotatable element (not shown) connecting to the polarizer 112. The polarizer 112 can then be rotated to change the polarization orientation of the first light ray L1.

As shown in FIG. 2A, the first light ray L1 generated by the first light module 110 has a polarization orientation P1. Referring to FIG. 2B, when the polarization orientation P1 is parallel to the fiber direction F, the stereoscopic microcamera module 130 outputs an image 1300, being a bright field image. The bright field image as shown in FIG. 2B illustrates a direction of fibers 51 and a distribution of toughened particles 50 on the surface layer of the composite material. In other words, when the polarization orientation P1 of the first light ray L1 is substantially the same as the fiber direction F on the surface layer of the composite material 5, the image 1300 captured by the stereoscopic microcamera module 130 represents the surface characteristics of the composite material.

More specifically, the parallel fibers 51 on the surface layer of the composite material 5 act like a polarizer. When the polarization orientation P1 of the first light ray L1 is substantially parallel to the fiber direction F, most of the light emitted by the first light ray L1 can be reflected by the surface fibers 51 of the composite material 5 instead of being absorbed. The light reflected by the fibers 51 are captured by the stereoscopic microcamera module 130. The stereoscopic microcamera module 130 outputs the bright field image of the surface layer of the composite material.

To the contrary, if the polarization adjustment element 113 alters the polarization orientation P1 of the first light ray L1 by approximately 90°, a polarization orientation P2 is then created as shown in FIG. 2C. In this regard, the polarization orientation P2 of the first light ray L1 and the surface fiber direction F of the composite material 5 are substantially orthogonal. The image 1300 captured by the stereoscopic microcamera module 130 is therefore a dark field image as shown in FIG. 2D.

Specifically, when the polarization orientation P2 of the first light ray L1 is substantially orthogonal to the fiber direction F, most of the light, emitted by the first light ray L1 onto the inspection area 500 of the composite material 5, is absorbed by the surface fibers 51 of the composite material 5. The light is not reflected to the stereoscopic microcamera module 130 and therefore the surface fibers 51 of the composite material 5 cannot be visualized in the dark field image. However, the surface toughened particles 50 distributed on the composite material 5 can reflect the first light ray L1 and be captured by the stereoscopic microcamera module 130. Therefore, in the 2D dark field image, toughened particles 50 are shown as bright spots. The distribution properties of toughened particles 50 can be obtained from the 2D image, including the size, density and uniformity of the toughened particles 50.

From the images output by the stereoscopic microcamera module 130, information related to the composite material 5 can be obtained. When the image is a bright field image, the fiber direction F and the polarization orientation of the first light ray L1 (and the second light ray L2) is the same. Hence, the fiber direction F on the surface layer of the composite material 5 can be deduced by the bright field image and the polarization orientation of the first light ray L1. When the image is a dark field image, the fiber direction F and the polarization orientation of the first light ray L1 (and the second light ray L2) is substantially orthogonal. The dark field image cannot show the fibers 51 yet the toughened particles 50 are visualized. Thus, the size, density and distribution uniformity of the toughened particles 51 can be analyzed.

In the previous embodiment, the fiber direction F on the surface layer or the distribution of toughened particles 50 is evaluated by the polarization orientation of the first and second light rays L1, L2. The polarization orientation is altered by adjusting the polarization adjustment element 113. In another embodiment, the same purpose can be achieved by adjusting the adjustment system 140 to alter the incident angle of the first and second light rays L1, L2 in respect to the composite material 5.

The adjustment system 140 is coupled to the first and second light modules 110, 120 for adjusting the incident angle or direction of the first and second light rays L1, L2 in respect to the composite material 5. Please refer to FIG. 1. The adjustment system 140 of the instant embodiment includes an annular rack 141 and a tuning element 142 for adjusting the incident direction of the first and second light rays L1, L2 in respect to the inspection area 500.

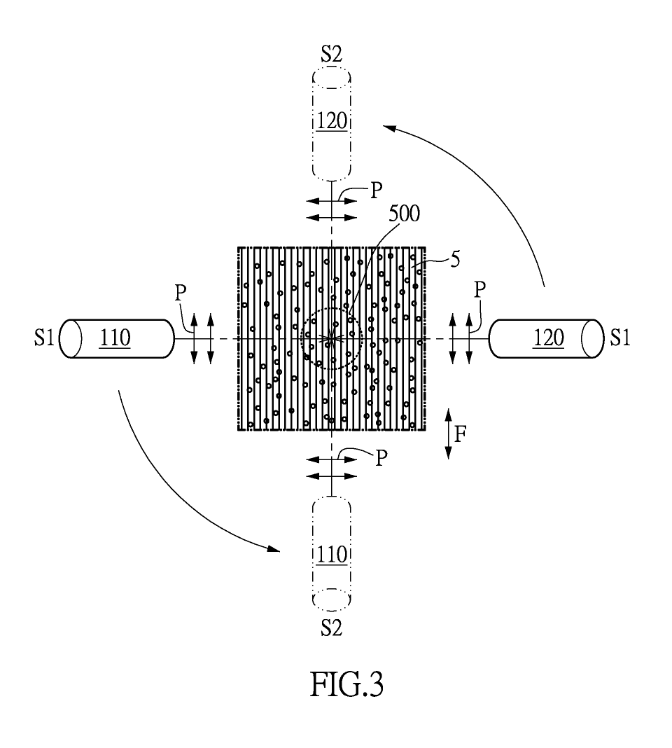

The annular rack 141 encircles the stereoscopic microcamera module 130 and the first and second light modules 110, 120 are coupled to the annular rack 141. In the instant embodiment, the first and second light modules 110, 120 are oppositely arranged. The tuning element 142 connects the annular rack 141 such that the annular rack 141 can rotate in respect to the stereoscopic microcamera module 130. When the annular rack 141 rotates, the first and second light modules 110, 120 are brought to rotation in respect to the central axis of the stereoscopic microcamera module 130. Please refer to FIG. 3. FIG. 3 is a top schematic view of the first and second light modules 110, 120 lighting on different positions on the surface of the composite material 5. That is, if a spherical coordinate system is used, the longitude of the first and second light modules 110, 120 changes along with the rotation of the annular rack 141. The incident direction of the first and second light rays L1, L2 is also altered thereby. In addition, in the instant embodiment, the tuning element 142 can have a tuning scale 1420. The polarization orientation of the first and second light rays L1, L2 changes in relation to the longitude of the first and second light modules 110, 120. Therefore, according to the longitude coordinate, which indicates the longitude of the first and second light modules 110, 120, on the tuning scale 1420, the polarization orientation of the first and second light rays L1, L2 at different longitudes can be obtained.

In FIG. 3, when the first and second light modules 110, 120 are at a position S1, the polarization orientation P and the fiber direction F of the first and second light rays L1, L2 in respect to the composite material surface are substantially the same. In this regard, the stereoscopic microcamera module 130 outputs an image similar to the bright field image as shown in FIG. 2B.

When the first and second light modules 110, 120 rotate for about 90° to a position S2, the polarization orientation P and the fiber direction F of the first and second light rays L1, L2 in respect to the composite material surface are substantially orthogonal. Meanwhile, the stereoscopic microcamera module 130 outputs an image similar to the dark field image as shown in FIG. 2D.

Please refer to FIG. 1. In the instant embodiment, the adjustment assembly 140 further includes a pair of lifting elements 143a, 143b and a pair of angle positioning elements 144a, 144b. In the instant embodiment, the lifting element 143a connects to the first light module 110 while the lifting element 143b connects to the second light module 120. The first and second light modules 110, 120 are hanged from the annular rack 141 by the lifting elements 143a, 143b respectively. The lifting elements 143a, 143b direct the first and second light modules 110, 120 toward or away from the surface of the composite material 5. In the instant embodiment, the lifting elements 143a, 143b provide the freedom to the first and second light modules 110, 120 in the Z direction.

The angle positioning element 144a is coupled between the lifting element 143a and the first light module 110 for altering the incident light angle of the first light ray L1 upon the first light module 110 being lifted. The angle positioning element 144b is adjusted for altering the incident light angle of the second light ray L2 upon the second light module 120 being lifted. As shown in FIG. 1, when the first and second light modules 110, 120 are positioned at SA, the first and second light rays L1, L2 have an incident angle θa in respect to the inspection area 500. When the first and second light modules 110, 120 are lowered to the position SB, the angle positioning elements 144a, 144b simultaneously reduce the incident angle of the first and second light rays L1, L2 in respect to the inspection area 500. Hence, the incident angle θb is smaller than θa. This cooperation ensures that the first and second light rays L1, L2 project to the same inspection area 500 regardless the changes of the first and second light modules 110, 120 in the Z direction.

The stereoscopic microcamera module 130 includes a lens holder 131 and a lens module 132. The lens module 132 is disposed in the lens holder 131. In the instant embodiment, the composite material inspection apparatus further includes a positioning assembly 160, which is optional. The positioning assembly 160 surrounds the periphery of the lens holder 131 and has at least one positioning pillar 161. The positioning pillars 161 support the lens holder 131 and fix the distance between the bottom of lens holder 131 and the inspection area 500 of the composite material. The positioning assembly 160 facilitates the stereoscopic microcamera module 130 in rapidly focusing on the composite material 5 for inspection.

More specifically, when the positioning pillars 161 abut the surface of the composite material 5 and the first and second light modules 110, 120 respectively emit the first and second light rays L1, L2 to the inspection area 500, the bottoms of positioning pillars 161 are co-planar to the inspection area 500 In this regard, the testing area 500 falls right within the depth of field of the lens module 132. When the stereoscopic microcamera module 130 captures images of multiple inspection areas, the distance between the stereoscopic microcamera module 130 and the inspection area 500 is fixed. Only the focal length of the stereoscopic microcamera module 130 needs to be slightly adjusted before taking another image.

In another embodiment of the instant disclosure, the first and second light rays L1, L2 emitted by the first and second light modules 110, 120 are unpolarized light. When the stereoscopic microcamera module 130 captures images of the inspection area 500 of the composite material 5, the annular rack 142 is brought to rotation by the tuning element 141. Consequently, the longitude of the first and second light modules 110, 120 is altered and therefore the incident direction of the first and second light rays L1, L2 in respect to the inspection area 500 is changed altogether. The angle positioning elements 144a, 144b also adjust the incident angle of the first and second light rays L1, L2 in respect to the composite material 5. The integration brings out an incident angle equivalent to a Brewster's angle. In one embodiment, the incident angle of the first and second light rays L1, L2 in respect to the composite material 5 ranges approximately between 30° to 60°.

It is known by the person skilled in the art that when an unpolarized light attacks a medium in Brewster's angle, the reflection and refraction lights are polarized. In the instant embodiment, when the adjustment system 140 alters the incident angle of the first and second light ray L1, L2 in respect to the inspection area 500 such that polarization orientation of the the reflection light R is parallel to the fiber direction F, the image output by the stereoscopic microcamera module 130 is a bright field image. When the adjustment system 140 alters the incident angle of the first and second light ray L1, L2 in respect to the inspection area 500 such that polarization orientation of the reflection light R is orthogonal to the fiber direction F, the image output by the stereoscopic microcamera module 130 is a dark field image.

The processing module 150 includes a processing unit 151, a display unit 152 and a control unit 153. The processing unit 151 is, for example, a processor. The processing unit 151 is coupled to the stereoscopic microcamera module 130, first and second light modules 110, 120 or/and adjustment assembly 140. The processing unit 151 receives images from the stereoscopic microcamera module 130 and undergoes further processing. The fiber direction F of the composite material 5 or the distribution properties (size, density, uniformity) of toughened particles 50 can be obtained. The processing unit 151 also stores the relations between the distribution properties and G_{IC} or CAI. After the processing unit 151 analyzes the distribution properties, the data is compared with the stored relations and then G_{IC} and CAI can be predicted.

The display unit 152 is coupled to the processing unit 151 and converts the signals from the processing unit 151 to a visual format. The parameters indicating fiber direction or distribution properties of toughened particles are shown on the display unit 152. The control unit 153 is coupled to the processing unit 151 for receiving any commend from an operator. Hence, by operating on the processing unit 151, the first and second light modules 110, 120 or the adjustment system 140 can be adjusted and therefore the incident angle, direction or polarization orientation of the first light ray L1 (or the second light ray L2) can be altered.

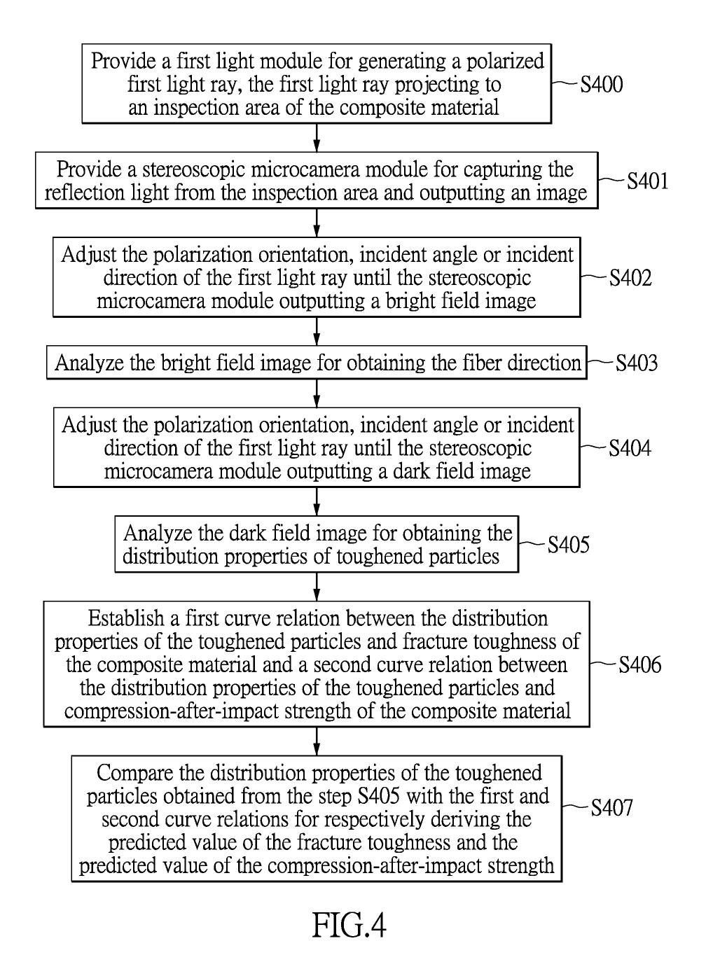

Please refer to FIG. 4. FIG. 4 is a flow chart of a non-destructive composite material inspection apparatus in accordance with an embodiment of the instant disclosure.

Firstly, in step S400, a first light module is provided. The first light module generates a first light ray projecting to the inspection area of the composite material. In the instant embodiment, the first light ray is polarized with a polarization orientation. Also, the first light ray projects to the inspection area in a predetermined incident angle and direction.

In step S401, a stereoscopic microcamera module is provided for capturing the reflection light from the inspection area and outputting images.

In step S402, the polarization orientation, incident angle or direction of the first light ray is adjusted such that the stereoscopic microcamera module outputs a bright field image.

In the instant embodiment, the abovementioned composite material inspection apparatus 1 can be used to perform the inspection. The tuning element 142 and the annular rack 141 are adjusted to alter the incident direction of the first light ray L1. The polarization adjustment element 113 of the first light module 110 can also be adjusted to alter the polarization orientation of the first light ray L1.

In another embodiment, the polarization orientation of the first light ray is fixed and only the incident direction thereof is altered. When rotating a predetermined angle, for example, 10°, the stereoscopic microcamera module camera captures images continuously until a bright field image is obtained. From the longitude coordinate of the first light module, the polarization orientation of the first light ray is deduced.

In still another embodiment, the incident direction of the first light is fixed and the polarization orientation of the first light ray L 1 is altered by constantly adjusting the polarization adjustment element 113 until a bright filed image is obtained by the stereoscopic microcamera module.

Subsequently in step S403, the bright field image is analyzed and the fiber direction on the surface layer of the composite material can be derived. As mentioned previously, when the stereoscopic microcamera module outputs a bright field image, the fiber direction on the surface layer of the composite material and the polarization orientation of the first light ray is substantially the same. In addition to fiber direction, in the bright field image, the toughened particle distribution can also be seen.

In step S404, the polarization orientation, incident angle or direction of the first light ray is adjusted such that the stereoscopic microcamera module outputs a dark field image.

In step S405, the dark field image is analyzed and the distribution of the toughened particles can be derived. As mentioned previously, when the stereoscopic microcamera module outputs a dark field image, the fiber direction of the composite material and the polarization orientation of the first light ray are substantially orthogonal. It is due to the absorption of the first light ray by the surface fibers of the composite material and only the toughened particles reflect a portion of the light. In the dark field image, only the bright spots created by the toughened particles are visualized and therefore the distribution properties of the toughened particles can be analyzed.

In the instant embodiment, the inspection method further includes step S406. A first curve relation between the particle distribution properties and G_{IC} is established. A second curve relation between the particle distribution properties and CAI is also established.

In step S407, the particle distribution properties obtained from step S405 are compared with the first and second curve relations. The values of G_{IC} and CAI are then predicted. In short, the non-destructive composite material inspection apparatus of the instant disclosure performs inspection without damaging the materials. The materials to be inspected do not need to be sliced. Hence, the apparatus and method can greatly reduce inspection time. Additionally, the apparatus is able to integrate with the production line to monitor the abovementioned physical properties of composite material. The apparatus may also integrate with a mechanical inspection system to optimize the processing parameters.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A non-destructive composite material inspection apparatus, a surface layer of composite material including a plurality of fibers having a fiber direction and a plurality of toughened particles distributed on the surface layer, comprising:
a first light module generating a first light ray projecting to a inspection area of the composite material surface, wherein the first light ray is polarized in a polarization orientation; and
a stereoscopic microcamera module capturing the reflection light from the inspection area and outputting an image;
wherein when the polarization orientation and the fiber direction are parallel, the image is a bright field image for analyzing the fiber direction and toughened particle distribution whereas when the polarization orientation and the fiber direction are orthogonal, the image is a dark field image for analyzing the toughened particle distribution and predicting the toughness of the composite material.

2. The non-destructive composite material inspection apparatus according to claim 1, wherein the first light module comprises:
a first light source generating an unpolarized initial light; and
a polarizer disposed on the light emitting face of the first light source for polarizing the initial light to the polarized light.

3. The non-destructive composite material inspection apparatus according to claim 2, wherein the polarizer is a linear polarizer and the polarized light is a linearly polarized light.

4. The non-destructive composite material inspection apparatus according to claim 2, wherein the first light module further comprises a polarization adjustment element for adjusting the polarization orientation.

5. The non-destructive composite material inspection apparatus according to claim 4, wherein the polarization adjustment element is a magnetic polarization rotator, disposed on the light emitting face of the polarizer and standing on the polarization light propagation path.

6. The non-destructive composite material inspection apparatus according to claim 4, wherein the polarization adjustment element is a rotatable element coupled to the polarizer for adjusting the polarization orientation via the polarizer.

7. The non-destructive composite material inspection apparatus according to claim 1 further comprising an adjustment assembly coupled to the first light module for adjusting an incident angle or an incident direction of the first light ray in respect to the surface of the composite material.

8. The non-destructive composite material inspection apparatus according to claim 7, wherein the adjustment system further comprises:
an annular rack surrounding the stereoscopic microcamera module and coupled to the first light module; and
a tuning element coupled to the annular rack and allowing the annular rack for rotating in respect to the stereoscopic microcamera module for adjusting the incident direction.

9. The non-destructive composite material inspection apparatus according to claim 7, wherein the adjustment assembly further comprises:
a lifting element connected to the first light module for controlling the first light module toward or away from the surface of the composite material; and
an angle positioning element connecting the lifting element and the first light module in cooperation with the lifting of the first light module for adjusting the incident angle of the first light ray.

10. The non-destructive composite material inspection apparatus according to claim 7 further comprising a processing module including:
a processing unit coupled to the stereoscopic microcamera module, the first light module and the adjustment assembly, wherein the processing unit captures the image and undergoes image processing for obtaining the fiber direction on the surface layer of the composite material or the distribution properties of toughened particles on the surface layer of the composite material;
a display unit couple to the processing unit and showing the fiber direction or the distribution properties of toughened particles on the surface layer of the composite material; and
a control unit coupled to the processing unit for controlling the first light module or the adjustment system via the processing unit and adjusting the incident angle, incident direction and polarization orientation of the first light ray.

11. The non-destructive composite material inspection apparatus according to claim 1 further comprising: a second light module generating a second light ray having the same polarization orientation with the first light ray and projecting to the same inspection area as the first light ray.

12. The non-destructive composite material inspection apparatus according to claim 1 further comprising a positioning assembly including at least one positioning pillar, wherein the positioning assembly supports a lens holder of the stereoscopic microcamera module, and the bottom of the positioning pillar is co-planar to the inspection area, when the first light module projects the first light ray onto the inspection area, the inspection area falls within the depth of field of a lens module of the stereoscopic microcamera module.

13. A non-destructive composite material inspection apparatus, the surface layer of composite material including a plurality of fibers having a fiber direction and a plurality of toughened particles distributed on the surface, comprising:
a light module generating an unpolarized light ray;
an adjustment assembly coupled to the light module for adjusting an incident angle and an incident direction of the light ray relative to the surface of the composite material, the incident angle is the Brewster's angle; and
a stereoscopic microcamera module capturing a reflection light from the inspection area and outputting an image;
wherein when a polarization orientation of the reflection light and the fiber direction are parallel, the image is a bright field image for analyzing the fiber direction and toughened particle distribution whereas when the polarization orientation of the reflection light and the fiber direction are orthogonal, the image is a dark field image for analyzing the toughened particle distribution and predicting the toughness of the composite material.

14. A method of non-destructive composite material inspection, the surface layer of composite material including a plurality of fibers having a fiber direction and a plurality of toughened particles distributed on the fibers, comprising:
providing a first light module for generating a polarized first light ray, wherein the first light ray projects to a inspection area of the composite material in an incident angle and an incident direction;
providing a stereoscopic microcamera module for capturing a reflection light from the inspection area and outputting an image;
adjusting the polarization orientation, incident angle or incident direction of the first light ray until the stereoscopic microcamera module outputting a bright or a dark field image; and
analyzing the bright or the dark field image for obtaining the fiber direction or the distribution properties of toughened particles.

15. The method of non-destructive composite material inspection according to claim 14 further comprising:
establishing a first curve relation between the distribution properties of the toughened particles and fracture toughness of the composite material;
establishing a second curve relation between the distribution properties of the toughened particles and compression-after-impact strength of the composite material;
comparing the distribution properties of the toughened particles obtained from the dark field image with the first curve relation for deriving a predicted value of the fracture toughness; and
comparing the distribution properties of the toughened particles obtained from the dark field image with the second curve relation for deriving a predicted value of the compression-after-impact strength.
